(19) United States
(12) Patent Application Publication
(10) Pub. No.: US 2007/0092029 A1
(43) Pub. Date: Apr. 26, 2007

(54) Apparatus to generate a dual transport stream and method thereof

(75) Inventors: Jung-pil Yu, Suwon-si (KR); Hae-joo Jeong, Seoul (KR); Eui-jun Park, Seoul (KR); Joon-soo Kim, Seoul (KR); Yong-sik Kwon, Seoul (KR); Jin-Hee Jeong, Anyang-si (KR); Yong-deok Chang, Suwon-si (KR); Kum-ran Ji, Seoul (KR); Jong-hun Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/504,030

(22) Filed: Aug. 15, 2006

Related U.S. Application Data
(60) Provisional application No. 60/728,777, filed on Oct. 21, 2005.
(60) Provisional application No. 60/734,295, filed on Nov. 8, 2005.
(60) Provisional application No. 60/738,050, filed on Nov. 21, 2005.
(60) Provisional application No. 60/739,448, filed on Nov. 25, 2005.
(60) Provisional application No. 60/788,707, filed on Apr. 4, 2006.

(30) Foreign Application Priority Data
Jul. 20, 2006 (KR) 2006-68043

(51) Int. Cl. H04J 3/24; H04L 27/00

(52) U.S. Cl. 375/295; 370/474

(57) ABSTRACT

An apparatus to generate a dual transport stream including a duplicator that receives a turbo stream and that provides a parity insertion region for the turbo stream, and a multiplexer that receives a normal stream and that multiplexes the turbo stream processed by the duplicator and the normal stream to generate the dual transport stream. The duplicator provides the parity insertion region using a 1/2-rate conversion method or 1/4-rate conversion method. Only the turbo stream is detected prior to the transmission of the dual transport stream, and the parity is inserted into the parity insertion region so that the turbo stream can be robustly processed.

### CROSS-REFERENCE TO RELATED APPLICATIONS

This application claims the benefit of Korean Application No. 2006-68043, filed Jul. 20, 2006, in the Korean Intellectual Property Office, and U.S. Provisional Patent Application Nos. 60/728,777 filed on Oct. 21, 2005; 60/734,295 filed on Nov. 8, 2005; 60/738,050 filed on Nov. 21, 2005; 60/739,448 filed on Nov. 25, 2005 and 60/788,707 filed on Apr. 4, 2006, in the United Sates Patent and Trademark Office, the disclosures of which are incorporated herein by reference.

### BACKGROUND OF THE INVENTION

1. Field of the Invention

Aspects of the present invention relate to an apparatus to generate a dual transport stream including a normal stream and a turbo stream and a method thereof, and more particularly, an apparatus to generate a dual transport stream including a normal stream and a turbo stream and a method thereof, which can improve the digital broadcasting performance by generating the dual transport stream including the normal stream and the turbo stream robustly processed in order to improve the receiving performance of an Advanced Television Systems Committee (ATSC) Vestigial Side Band (VSB) system that is the American-type digital terrestrial broadcasting system.

2. Description of the Related Art

An Advanced Television Systems Committee (ATSC) Vestigial Side Band (VSB) system, which is an American-type digital terrestrial broadcasting system, is a signal carrier type broadcasting system that uses a field sync signal having a unit of 312 segments. Accordingly, its receiving performance is not good in an inferior channel, and, particularly, in a Doppler fading channel.

FIG. 1 is a block diagram illustrating the construction of a transmitter/receiver of an ATSC DTV standard as a general American-type digital terrestrial broadcasting system. The digital broadcast transmitter of FIG. 1 is an enhanced VSB (EVSB) system proposed by Philips that forms and transmits a dual stream provided by adding robust data to normal data of the basic ATSC VSB system.

As illustrated in FIG. 1, the digital broadcast transmitter includes a randomizer 11, which randomizes a dual stream; a Reed-Solomon (RS) encoder 12 in the form of a concatenated coder that adds parity bytes to the transport stream in order to correct errors occurring due to the channel characteristic in a transport process; an interleaver 13, which interleaves the RS-encoded data according to a specified pattern; and a 2/3-rate trellis encoder 14, which maps the interleaved data onto 8-level symbols by performing a 2/3-rate trellis encoding of the interleaved data. The digital broadcast transmitter performs an error correction coding of the dual stream.

The digital broadcast transmitter further includes a multiplexer 15, which inserts a field sync signal and a segment sync signal into the error-correction-coded data as a data format in FIG. 2, and a modulator 16, which inserts a pilot tone into the data symbols into which the segment sync signal and the field sync signal have been inserted by adding specified DC values to the data symbols, performing a VSB modulation of the data symbols by pulse-shaping the data symbols, and up-converting the modulated data symbols into an RF channel band signal to transmit the RF channel band signal.

In the digital broadcast transmitter, the normal data and the robust data are multiplexed (not illustrated) according to a dual stream system that transmits the normal data and the robust data through one channel. The multiplexed data is inputted to the randomizer 11, which randomizes the data, outer-encoded through the RS encoder 120, and then distributed through the interleaver 13. Then, the interleaved data is inner-encoded with a unit of 12 symbols through the trellis encoder 14, and mapped onto the 8-level symbols. After the field sync signal and the segment sync signal are inserted into the coded data, the data is VSB-modulated by inserting a pilot tone into the data, and converted into an RF signal.

The digital broadcast receiver of FIG. 1 includes a tuner (not illustrated), which converts an RF signal received through a channel into a baseband signal; a demodulator 21, which performs a sync detection and demodulation of the converted baseband signal; an equalizer 22, which compensates for a channel distortion of the demodulated signal occurring due to multipath conditions; a Viterbi decoder 23, which corrects errors of the equalized signal and decodes the error-corrected signal to symbol data; a deinterleaver 24, which rearranges the data distributed by the interleaver 13 of the digital broadcast transmitter; an RS decoder 25, which corrects errors; and a derandomizer 26 which derandomizes the data corrected through the RS decoder 25 and outputs an MPEG-2 transport stream.

Accordingly, the digital broadcast receiver of FIG. 1 down-converts the RF signal into the baseband signal, demodulates and equalizes the converted signal, and then channel-decodes the demodulated signal to restore the original signal.

FIG. 2 illustrates a VSB data frame for use in the American type digital broadcasting (8-VSB) system, into which a segment sync signal and a field sync signal are inserted. As shown in FIG. 2, one frame comprises two fields, and each field comprises one field sync segment, which is the first segment and 312 data segments. Also, each segment in the VSB data frame corresponds to one MPEG-2 packet and comprises a segment sync signal of four symbols and 828 data symbols.

The segment sync signal and the field sync signal are used for synchronization and equalization in the digital broadcast receiver. That is, the field sync signal and the segment sync signal refer to known data between the digital broadcast transmitter and receiver, which is used as a reference signal when equalization is performed on the receiver side.

The American type digital terrestrial broadcasting system as illustrated in FIG. 1 is a system that can form and transmit a dual stream produced by adding the robust data to the normal data of the existing ATSC VSB system. This system transmits the robust data together with the existing normal data.

However, the American type digital terrestrial broadcasting system of FIG. 1 has the problem that it has almost no effect of improving the inferior receiving performance in a multipath channel in the transmission of the existing normal data, although it transmits the dual stream produced by adding the robust data to the normal data.

That is, the American type digital terrestrial broadcasting system has almost no effect of improving the receiving performance according to an improvement of the normal stream. Also, even with respect to a turbo stream, it does not have a great effect of improving the receiving performance in a multipath environment. Accordingly, it is required to generate a dual transport stream having a form in which a turbo stream can be robustly processed.

### SUMMARY OF THE INVENTION

Aspects of the present invention solve the above drawbacks and/or other problems associated with the conventional arrangement. An aspect of the present invention provides an apparatus to generate a dual transport stream including a normal stream and a turbo stream and a method thereof, which generates the dual transport stream including the normal stream and the turbo stream in order to improve the receiving performance of an Advanced Television Systems Committee (ATSC) Vestigial Side Band (VSB) system that is an American-type digital terrestrial broadcasting system, and which makes it possible to process the turbo stream more robustly by providing a region for inserting a parity for the turbo stream.

According to an aspect of the present invention, there is provided an apparatus to generate a dual transport stream, according to aspects of the present invention, which includes a duplicator that receives a turbo stream, and providing a parity insertion region for the turbo stream, and a multiplexer that receives a normal stream and that multiplexes the turbo stream processed by the duplicator and the normal stream to generate the dual transport stream.

The apparatus may, although not necessarily, further include an RS encoder performing an RS encoding of the turbo stream to output the RS-encoded turbo stream to the duplicator.

The apparatus may, although not necessarily, further include an interleaver interleaving the turbo stream.

The duplicator may, although not necessarily, convert each byte of the turbo stream according to a 1/2-rate conversion method to generate two bytes.

In this instance, the duplicator may, although not necessarily, divide each byte of the turbo stream by four bits to form two bit groups, and arrange a null bit for each bit of the respective bit groups to generate the two bytes.

The duplicator may, although not necessarily, convert each byte of the turbo stream according to a 1/4-rate conversion method to generate four bytes.

In this instance, the duplicator may, although not necessarily, divide each byte of the turbo stream by two bits to form four bit groups, and arrange three null bits for each bit of the respective bit groups to generate the four bytes.

The RS encoder may, although not necessarily, add a parity of 20 bytes to a turbo stream of 184 bytes.

Also, the dual transport stream may, although not necessarily, include a field of a plurality of packets, and the turbo stream may be arranged in the packet positioned at predetermined intervals in the field.

According to another aspect of the present invention, there is provided a method of generating a dual transport stream, which includes receiving a turbo stream, and providing a parity insertion region for the turbo stream; and receiving a normal stream and multiplexing the turbo stream provided with the parity insertion region and the normal stream to generate the dual transport stream.

The method may, although not necessarily, further include performing RS encoding of the received turbo stream.

The method may, although not necessarily, further include interleaving the turbo stream.

The receiving of the turbo stream, and providing a parity insertion region for the turbo stream, may, although not necessarily, convert each byte of the turbo stream according to a 1/2-rate conversion method to generate two bytes.

The receiving of the turbo stream, and providing a parity insertion region for the turbo stream, may, although not necessarily, divide each byte the turbo stream by four bits to form two bit groups, and arrange one null bit for each bit of the respective bit groups to generate the two bytes.

The receiving of the turbo stream, and providing a parity insertion region for the turbo stream, may, although not necessarily, convert each byte of the turbo stream according to a 1/4-rate conversion method to generate four bytes.

The receiving of the turbo stream, and providing a parity insertion region for the turbo stream, may, although not necessarily, divide each byte of the turbo stream by two bits to form four bit groups, and arrange three null bits for each bit of the respective bit groups to generate the four bytes.

The RS encoding may, although not necessarily, add a parity of 20 bytes to a turbo stream of 184 bytes.

The dual transport stream may, although not necessarily, include a field of a plurality of packets, and the turbo stream may be arranged in the packet positioned at predetermined intervals in the field.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating the construction of a transmitting/receiving system of a general American-type digital broadcasting (ATSC VSB) system;

FIG. 2 is a view illustrating the structure of an ATSC VSB data frame;

FIG. 3 is a block diagram illustrating the construction of an apparatus to generate a dual transport stream according to an embodiment of the present invention;

FIGS. 4 and 5 are views explaining various examples of a process of generating a parity insertion region in the apparatus to generate the dual transport stream in FIG. 3;

FIG. 6 is a block diagram illustrating the construction of an apparatus to generate a dual transport stream according to another embodiment of the present invention;

FIG. 7 is a view illustrating the structure of an RS-encoded packet in the apparatus to generate the dual transport stream in FIG. 3;

FIG. 8 is a block diagram illustrating the construction of an apparatus to generate a dual transport stream according to still another embodiment of the present invention; and

FIG. 9 is a view illustrating one example of a dual transport stream generated in the apparatus to generate a dual transport stream.

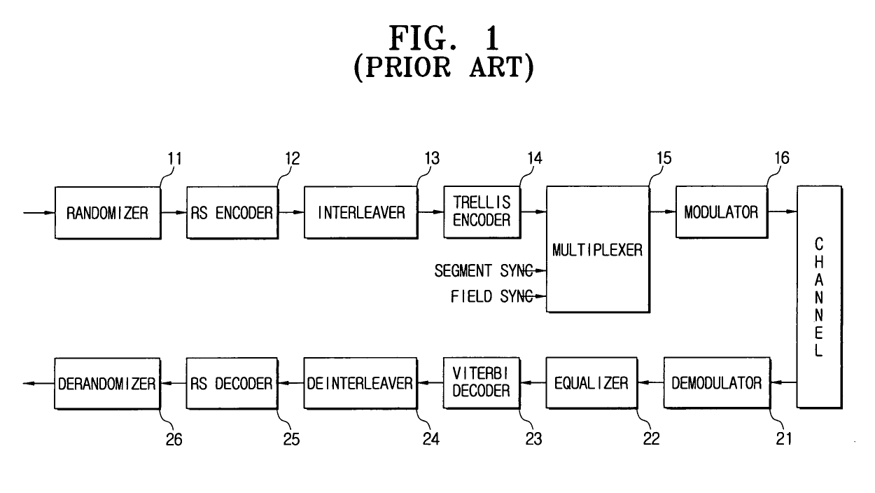

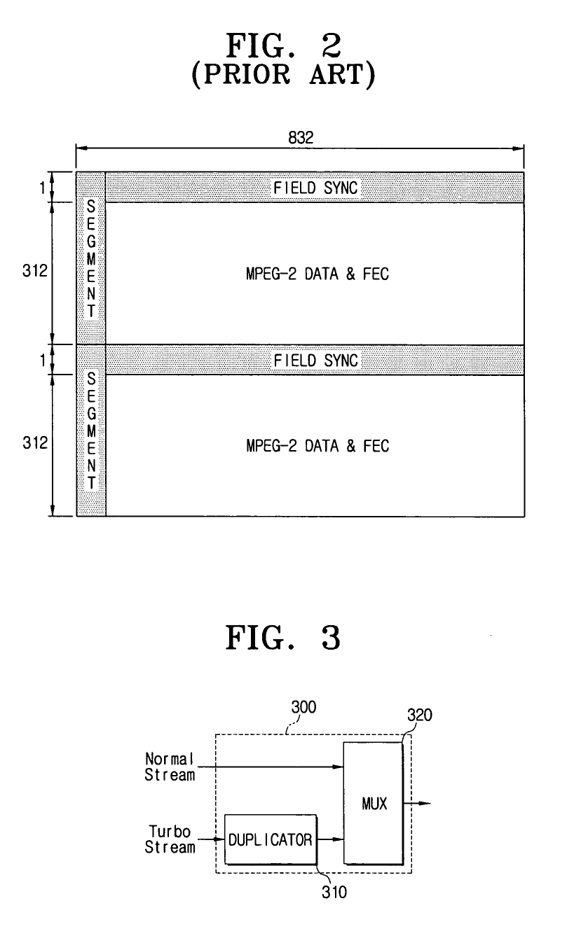

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 3 is a block diagram illustrating the construction of an apparatus 300 to generate a dual transport stream according to an embodiment of the present invention.

Referring to FIG. 3, the apparatus 300 to generate the dual transport stream includes a duplicator 310 and a multiplexer 320.

When the duplicator 310 receives a turbo stream, the duplicator 310 provides a parity insertion region in the turbo stream. The method of providing the parity insertion region will now be explained in more detail. Each byte, which is a constituent unit of the turbo stream, is divided into 2 or 4 bytes. The divided byte is filled with a fraction of the bit values of the original byte and duplicates of the bit values or null data (e.g., “0”). The region filled with the duplicates or the null data becomes the parity insertion region.

The operation of the duplicator 310 will now be described in detail. In the case of duplicating an input, where the bits comprising one byte may be expressed as a, b, c, d, e, f, g, h, starting from the most significant bit (MSB), and are inputted in order, the output of the duplicator 310 is a, a, b, b, c, c, d, d, e, e, f, f, g, g, h, h. In this instance, it will be understood that two bytes, i.e., one byte composed of a, a, b, b, c, c, d, d and one byte composed of e, e, f, f, g, g, h, h, starting from the MSB, are successively outputted. In the case of quadruplicating the input, the output of the duplicator 310 may be expressed as a, a, a, a, b, b, b, b, c, c, c, c, d, d, d, d, e, e, e, e, f, f, f, f, g, g, g, g, h, h, h, h. As such, four bytes are outputted.

Meanwhile, the duplicator 310 can insert null data in the parity insertion region without duplicating the input bit. For example, if the duplicator doubles the input, only the front part of two successive bits (e.g., a, x, b, x, c, x, . . .) may be maintained as the original input, and null data may be inserted into the rear part thereof. By contrast, only the rear part may be maintained as the original input (e.g., x, a, x, b, x, c, . . .). In the case of quadruplicating the input, the original input may also be positioned in any one of the first, second, third, and fourth positions, and null data may be inserted into the other positions.

The multiplexer 320 generates the dual transport stream by mixing the normal stream with the turbo stream processed by the duplicator 310. Meanwhile, the normal stream and the turbo stream may be received from an external module, such as a broadcast photographing device, or various kinds of internal modules, such as a compression processing module (e.g., MPEG-2 module), a video encoder, an audio encoder, and others.

The generated dual transport stream is transmitted to a receiving device through randomization, encoding, robust processing, sync-signal multiplexing, modulation, and other processes. In the robust processing, for example, only the turbo stream is detected from the dual transport stream, and the parity for the turbo stream is inserted into the parity insertion region provided by the duplicator 310 to make the turbo stream into a robust data stream.

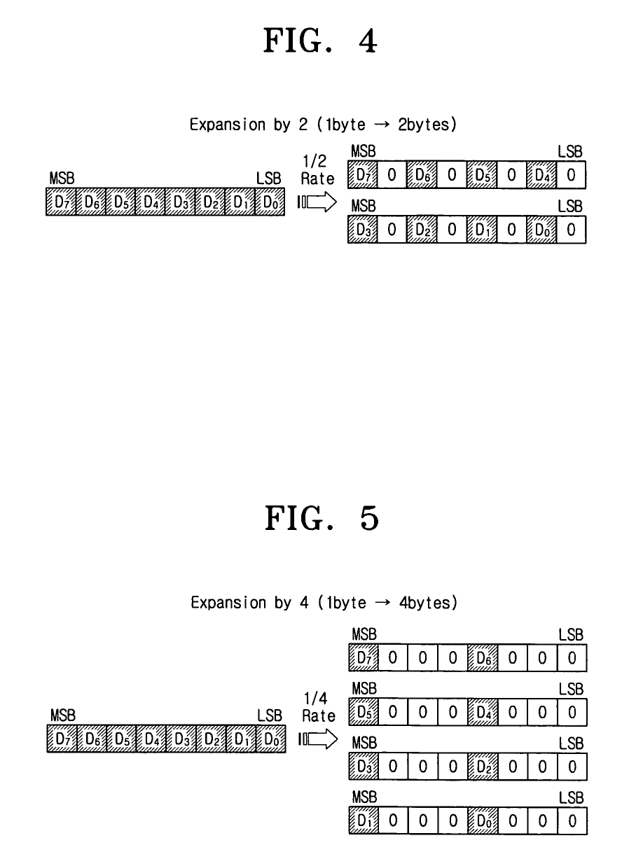

FIGS. 4 and 5 are views explaining various examples of the process in which the duplicator 310 generates the parity insertion region. First, FIG. 4 shows a 1/2-rate conversion method. The duplicator 310 generates two bytes by applying the 1/2-rate conversion method to each byte of the turbo stream. Referring to FIG. 4, one byte including bits of D0 through D7 is divided by four bits to form two bit groups D0 through D3 and D4 through D7. In this state, one null bit is arranged in order for each bit of the respective bit groups to expand each bit group into a byte. As a result, the first byte including the bits D4 through D7 (D7 0 D6 0 D5 0 D4 0) and the second byte including the bits D0 through D3 (D3 0 D2 0 D1 0 D0 0) are generated. The null bits are used as the parity insertion region. In other words, in the case of the first and second bytes, the 2nd, 4th, 6th, and 8th bits are used as the parity insertion region. However, this is not the only possible arrangement. The arranging position of the parity insertion region may be altered in a variety of ways. For example, the 2nd, 3rd, 6th, and 7th bits or the 3rd, 4th, 5th, and 6th bits may be used as the parity insertion region.

FIG. 5 shows a 1/4-rate conversion method. The duplicator 310 generates four bytes by applying the 1/4-rate conversion method to each byte of the turbo stream. Referring to FIG. 5, one byte including D0 through D7 bits is divided by two bits to form four bit groups D0-D1, D2-D3, D4-D5, and D6-D7. In this state, three null bits are arranged in order for each bit of the respective bit groups to expand each bit group into a byte. More specifically, the bit group is expanded into the first byte (D7 0 0 0 D6 0 0 0), the second byte (D5 0 0 0 D4 0 0 0), the third byte (D3 0 0 0 D2 0 0 0), and the fourth byte (D1 0 0 0 D 0 0 0 0). Referring to FIG. 5, the 2nd, 3rd, 4th, 6th, 7th, and 8th bits are used as the parity insertion region in the respective bytes. However, this is not the only possible arrangement. The arranging position of the parity insertion region may be altered in a variety of ways.

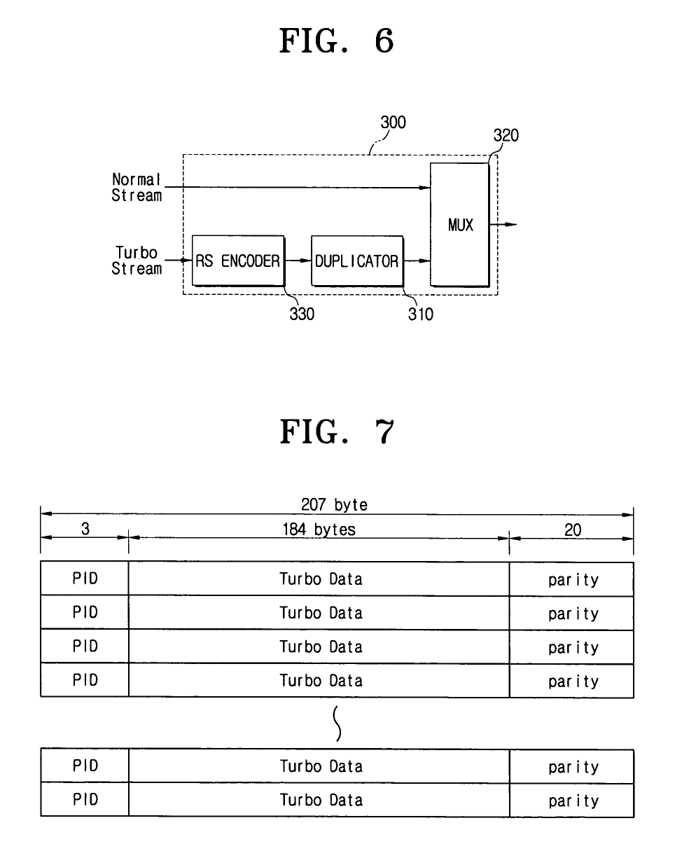

FIG. 6 is a block diagram illustrating the construction of an apparatus to generate a dual transport stream according to another embodiment of the present invention. In the embodiment shown in FIG. 6, an RS encoder 330 may be added in the apparatus 300 to generate the dual transport stream. The RS encoder 330 receives the turbo stream, inserts the parity into the turbo stream, encodes the stream, and provides it to the duplicator 310. Accordingly, the duplicator 310 provides the parity insertion region in the encoded turbo stream. Since the operation of the duplicator 310 and the multiplexer 320 is the same as that shown and explained with reference to FIG. 3, the detailed explanation thereof will be omitted.

FIG. 7 is a view illustrating one example of the structure of the packet RS-encoded by the RS encoder 330 in FIG. 6. The RS encoder 330 receives a sync signal, a packet identity (PID), and the turbo stream comprising a turbo data region. The whole turbo stream packet may comprise 188 bytes, in which the sync signal is 1 byte, the PID is 3 bytes, and the turbo data is 184 bytes. The RS encoder 330 eliminates the sync signal from the turbo stream, computes the parity for the turbo data region, and inserts the parity having a size of 20 bytes. As a result, one packet of finally encoded turbo stream comprises a total of 207 bytes, in which 3 bytes are allocated to the PID, 184 bytes are allocated to the turbo data, and 20 bytes are allocated to the parity.

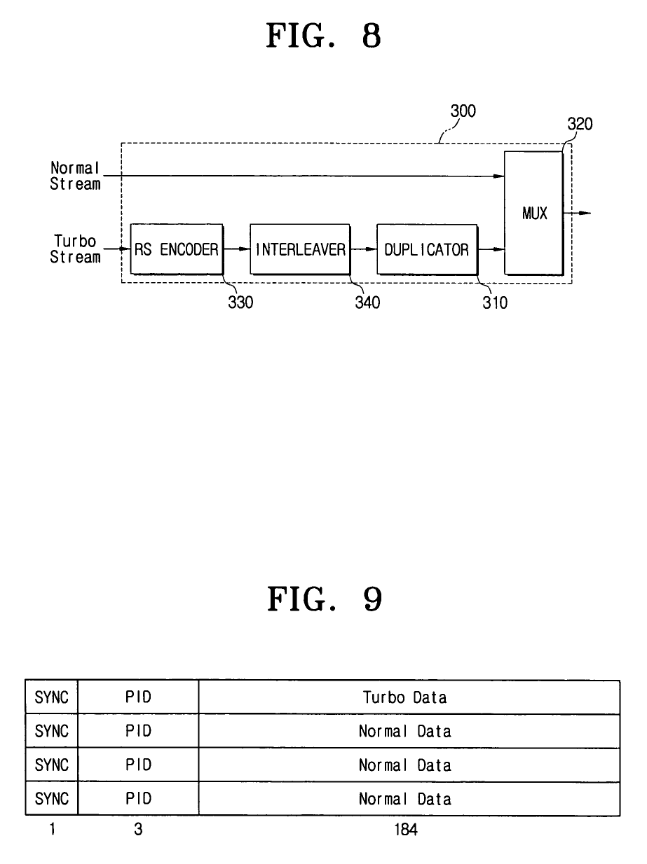

FIG. 8 is a block diagram illustrating another embodiment in which an interleaver is added in the apparatus to generate the dual transport as shown in FIG. 6. The interleaver 340 interleaves the turbo stream encoded by the RS encoder 330, and provides the interleaved stream to the duplicator 310. The positions of the interleaver 340 and duplicator 310 may be changed.

FIG. 9 is a view illustrating one example of the dual transport stream generated in the apparatus to generate the dual transport stream. Referring to FIG. 9, the dual transport stream comprises a plurality of successive packets. One packet may comprise 188 bytes. More specifically, one packet may comprise 1 byte of sync signal, 3 bytes of PID, and 184 bytes of data region. As shown in FIG. 9, the robust data, i.e., turbo stream, is positioned in a specified packet of the dual transport stream. More specifically, FIG. 9 shows the state in which 78 packets of the turbo streams are inserted into 312 packets of one field of the dual transport stream. In this instance, the dual transport stream comprises 4 successive packets in which there is a 1:3 ratio of turbo stream packets to normal stream packets. That is, one packet (188 bytes) of the turbo stream and three packets (188 bytes) of the normal stream are successively arranged. Meanwhile, the structure of the dual transport stream may be modified depending upon diverse embodiments of the present invention.

The method of generating the dual transport stream according to aspects of the present invention may be described with reference to FIGS. 3, 6, and 8, and the flowchart thereof will be omitted herein. That is, the normal stream and the turbo stream are separately received, and the parity insertion region is provided only in the turbo stream. Then, the turbo stream and the normal stream are multiplexed to generate the dual transport stream. In this instance, the turbo stream may be encoded, and the encoded turbo stream may be interleaved prior to providing the parity insertion region. The method of providing the parity insertion region has been explained with reference to FIGS. 4 and 5, and the structure of the encoded turbo stream has been explained with reference to FIG. 7. Therefore, any additional description thereof will be omitted.

As described above, the apparatus to generate the dual transport stream according to aspects of the present invention can generate the dual transport stream including the normal stream and the turbo stream in order to improve the receiving performance of the Advanced Television Systems Committee (ATSC) Vestigial Side Band (VSB) system that is the American-type digital terrestrial broadcasting system. In this instance, the turbo stream can be more robustly processed by providing the parity insertion region in the turbo stream. Also, the apparatus to generate the dual transport stream is compatible with the existing normal data transmitting system, and, thus, can improve the receiving performance in diverse receiving environments with a simple construction.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus to generate a dual transport stream, the apparatus comprising:
a duplicator receiving a turbo stream, and providing a parity insertion region in the turbo stream; and
a multiplexer receiving a normal stream, and multiplexing the turbo stream processed by the duplicator and the normal stream to generate the dual transport stream.

2. The apparatus as claimed in claim 1, further comprising a Reed-Solomon (RS) encoder performing an RS encoding of the turbo stream to output the RS-encoded turbo stream to the duplicator.

3. The apparatus as claimed in claim 2, further comprising an interleaver interleaving the turbo stream.

4. The apparatus as claimed in claim 3, wherein the interleaver interleaves the turbo stream after the duplicator provides the parity insertion region in the turbo stream.

5. The apparatus as claimed in claim 3, wherein the interleaver interleaves the turbo stream before the duplicator provides the parity insertion region in the turbo stream.

6. The apparatus as claimed in claim 1, wherein the duplicator provides the parity insertion region in the turbo stream by dividing each byte of the turbo stream into a number of bit groups, and generating one new byte for each bit group, each new byte comprising parity insertion bits and the bit group, wherein the parity insertion region comprises the parity insertion bits.

7. The apparatus as claimed in claim 6, wherein the parity insertion bits are null bits.

8. The apparatus as claimed in claim 6, wherein the parity insertion bits have a value replicating the value of respective bits of the bit group.

9. The apparatus as claimed in claim 6, wherein the duplicator converts each byte of the turbo stream according to a 1/2-rate conversion method to generate two new bytes.

10. The apparatus as claimed in claim 9, wherein the duplicator divides each byte of the turbo stream by four bits to form two bit groups, and arranges one parity insertion bit for each bit of the respective bit groups to generate the two new bytes.

11. The apparatus as claimed in claim 6, wherein the duplicator converts each byte of the turbo stream according to a 1/4-rate conversion method to generate four new bytes.

12. The apparatus as claimed in claim 11, wherein the duplicator divides each byte of the turbo stream by two bits to form four bit groups, and arranges three parity insertion bits for each bit of the respective bit groups to generate the four new bytes.

13. The apparatus as claimed in claim 2, wherein the RS encoder adds a parity of 20 bytes to a turbo stream of 184 bytes.

14. The apparatus as claimed in claim 13, wherein the RS encoder removes a sync signal from the turbo stream.

15. The apparatus as claimed in claim 13, wherein the RS encoder determines the parity for the turbo stream.

16. The apparatus as claimed in claim 1, wherein the dual transport stream comprises a field of a plurality of packets, and the turbo stream is arranged in the packet positioned at predetermined intervals in the field.

17. A method of generating a dual transport stream, comprising:
receiving a turbo stream, and providing a parity insertion region in the turbo stream; and
receiving a normal stream and multiplexing the turbo stream provided with the parity insertion region and the normal stream to generate the dual transport stream.

18. The method as claimed in claim 17, further comprising performing RS encoding of the received turbo stream.

19. The method as claimed in claim 18, further comprising interleaving the turbo stream.

20. The method as claimed in claim 19, wherein the interleaving of the turbo stream is performed after the providing the parity insertion region in the turbo stream.

21. The method as claimed in claim 19, wherein the interleaving of the turbo stream is performed before the providing the parity insertion region in the turbo stream.

22. The method as claimed in claim 17, wherein the providing of the parity region in the turbo stream comprises:
dividing each byte of the turbo stream into a number of bit groups, and
generating one new byte for each bit group, each new byte comprising parity insertion bits and the bit group, wherein the parity insertion region comprises the parity insertion bits.

23. The method as claimed in claim 22, wherein the parity insertion bits are null bits.

24. The method as claimed in claim 22, wherein the parity insertion bits have a value replicating the value of respective bits of the bit group.

25. The method as claimed in claim 22, wherein the dividing of each byte of the turbo stream into the number of bit groups comprises converting each byte of the turbo stream according to a 1/2-rate conversion method to generate two new bytes.

26. The method as claimed in claim 25, wherein the dividing of each byte of the turbo stream into the number of bit groups comprises:
dividing each byte of the turbo stream by four bits to form two bit groups, and
arranging one parity insertion bit for each bit of the respective bit groups to generate the two new bytes.

27. The method as claimed in claim 22, wherein the dividing of each byte of the turbo stream into the number of bit groups comprises converting each byte of the turbo stream according to a 1/4-rate conversion method to generate four new bytes.

28. The method as claimed in claim 27, wherein the dividing of each byte of the turbo stream into the number of bit groups comprises:
dividing each byte of the turbo stream by two bits to form four bit groups, and
arranging three parity insertion bits for each bit of the respective bit groups to generate the four new bytes.

29. The method as claimed in claim 18, wherein the RS encoding is performed to add a parity of 20 bytes to a turbo stream of 184 bytes.

30. The method as claimed in claim 29, wherein the RS encoding is performed to remove a sync signal from the turbo stream.

31. The method as claimed in claim 29, wherein the RS encoding is performed to determine the parity for the turbo stream.

32. The method as claimed in claim 17, wherein the dual transport stream comprises a field of a plurality of packets, and the turbo stream is arranged in the packet positioned at predetermined intervals in the field.

33. An apparatus to generate a dual transport stream, the apparatus comprising a duplicator receiving a turbo stream, and providing a parity insertion region in the turbo stream.

34. The apparatus as claimed in claim 33, further comprising a multiplexer receiving a normal stream, and multiplexing the turbo stream processed by the duplicator and the normal stream to generate the dual transport stream.

35. The apparatus as claimed in claim 33, further comprising a Reed-Solomon (RS) encoder performing an RS encoding of the turbo stream to output the RS-encoded turbo stream to the duplicator.

36. The apparatus as claimed in claim 35, further comprising an interleaver interleaving the turbo stream.

37. The apparatus as claimed in claim 36, wherein the interleaver interleaves the turbo stream after the duplicator provides the parity insertion region in the turbo stream.

38. The apparatus as claimed in claim 36, wherein the interleaver interleaves the turbo stream before the duplicator provides the parity insertion region in the turbo stream.

39. The apparatus as claimed in claim 33, wherein the duplicator provides the parity insertion region in the turbo stream by dividing each byte of the turbo stream into a number of bit groups, and generating one new byte for each bit group, each new byte comprising parity insertion bits and the bit group, wherein the parity insertion region comprises the parity insertion bits.

40. The apparatus as claimed in claim 39, wherein the parity insertion bits are null bits.

41. The apparatus as claimed in claim 39, wherein the parity insertion bits have a value replicating the value of respective bits of the bit group.

42. The apparatus as claimed in claim 39, wherein the duplicator converts each byte of the turbo stream according to a 1/2-rate conversion method to generate two new bytes.

43. The apparatus as claimed in claim 42, wherein the duplicator divides each byte of the turbo stream by four bits to form two bit groups, and arranges one parity insertion bit for each bit of the respective bit groups to generate the two new bytes.

44. The apparatus as claimed in claim 39, wherein the duplicator converts each byte of the turbo stream according to a 1/4-rate conversion method to generate four new bytes.

45. The apparatus as claimed in claim 44, wherein the duplicator divides each byte of the turbo stream by two bits to form four bit groups, and arranges three parity insertion bits for each bit of the respective bit groups to generate the four new bytes.
